(19) United States
(12) Patent Application Publication
(10) Pub. No.: US 2021/0401006 A1
(43) Pub. Date: Dec. 30, 2021

(54) POPCORN POPPER

(71) Applicant: AVID Labs, LLC, Fort Wayne, IN (US)

(72) Inventors: Joel A. Nichols, Columbia City, IN (US); Aaron Prins, Rockford, MI (US)

(73) Assignee: AVID Labs, LLC, Fort Wayne, IN (US)

(21) Appl. No.: 17/357,226

(22) Filed: Jun. 24, 2021

Related U.S. Application Data
(60) Provisional application No. 63/043,190, filed on Jun. 24, 2020.
(60) Provisional application No. 63/056,891, filed on Jul. 27, 2020.

(51) Int. Cl. A23L 7/183

(52) U.S. Cl. CPC A23L 7/183

(57) ABSTRACT

A popcorn popper including a cooking member having a cooking surface with at least one elevated support and at least one groove. The at least one elevated support providing for a downward flow of oil toward the at least one groove and an upward support of popped grain thereon.

### CROSS REFERENCE TO RELATED APPLICATIONS

This is a non-provisional application based upon U.S. provisional patent application Ser. No. 63/043,190, entitled “POPCORN POPPER”, filed Jun. 24, 2020, which is incorporated herein by reference; and also based upon U.S. provisional patent application Ser. No. 63/056,891, entitled “ROUNDED POPCORN POPPER”, filed Jul. 27, 2020, which is incorporated herein by reference

### BACKGROUND OF THE INVENTION

### 1. Field of the Invention

The present invention relates to a popcorn popper for the popping of grains of popcorn as they are cooked in oil.

### 2. Description of the Related Art

A popcorn popper (also referred to as a popcorn maker) is a machine used to pop popcorn. Since ancient times, popcorn has been a popular snack food, produced through the propensity of the corn kernel to explosively expand when heated. A commercial popcorn popping machine was invented by Charles Cretors in the late 19th century. Many types of small-scale home used devices for the popping of popcorn are also in use.

Commercial popcorn machines are commonly found in movie theaters and carnivals, producing popcorn in a pan of hot oil, such that approximately half of the calories are derived from the fat in the oil in which the corn is popped. A selling point of hot-air popcorn poppers for home use was that they eliminated the use of oil for the popping of corn, thereby essentially eliminating the calories derived from fat.

The process of making popcorn typically involves heating the corn kernels using a heat source, a cooking device, for example a pot, and a sufficient amount of oil. A prevalent issue in the process of making popcorn is the burning of the pre-cracked corn kernels and/or the cracked-open kernels, i.e., popped popcorn. Post-cracking, the popcorn may become burnt or otherwise overcooked if the popcorn remains in contact with the heated cooking surface of the cooking device and/or the heated oil therein. Often, an individual or popcorn machine will remove the popcorn from, or actively move the popcorn on, the heating surface to prevent the burning thereof while the remaining corn kernels continue to cook.

While a large percentage of the popcorn sold for home consumption is now packaged in a microwave popcorn bag for use in a microwave oven, the use of a small-scale device strongly appeals to the popcorn aficionado. Specialized popcorn pots, also called stove-top poppers, have been marketed under various brand names, including The Detonator, Whirley Pop, Theater II and Sweet & Easy; all of which are basically a pot that has an integrated stirring blade that is operated manually by the turning of a crank. This is to prevent burning of the kernels on the bottom and, under limited conditions, enables users to make sweetened popcorn by mixing sugar directly with the kernels before they pop. Home popcorn makers, made popular as a Stir-Crazy unit, are also available, consisting of an electrically heated circular tray with a powered stirring arm, into which popcorn and oil are placed, and a dome-shaped cover that doubles as a serving bowl.

Each of the forgoing poppers reduce the potential of burning the popped corn by actively moving the popped corn so as to reduce contact time of the popped kernel with the heat source.

What is needed in the art is a passive system that eliminates or reduces the burning of popped corn kernels as it is being popped.

### SUMMARY OF THE INVENTION

The present invention provides a popcorn popper with features that enhance the popping reduce the burning of popped kernels.

The invention in one form is directed to a popcorn popper including a cooking member having a cooking surface with at least one elevated support and at least one groove. The at least one elevated support providing for a downward flow of oil toward the at least one groove and an upward support of popped grain thereon.

The invention in another form is directed to a popcorn popper including a cooking member having a cooking surface with at least one elevated support and at least one groove. The at least one elevated support providing for a downward flow of oil toward the at least one groove and an upward support of popped grain thereon. A lid is removably placed on the cooking member.

An advantage of the present invention is that the popped corn is moved passively to a less hot portion of the cooking surface due to the geometry of the cooking surface.

Another advantage is that less heat is conducted to a middle of the cooking surface to reduce scorching of popped kernels of corn.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of a popcorn popper of the present invention;

FIG. 2 is a perspective-exploded view of the popcorn popper of FIG. 1 illustrating the bowl/lid in a position to hold popped corn;

FIG. 3 is a partial sectioned view of the pan or cooking member of FIGS. 1 and 2 illustrating details of the surface of the cooking member;

FIG. 4 is a perspective view of the cooking member of FIGS. 1-3, illustrating an embodiment of a pattern on the surface of the cooking member;

FIG. 5 is a top view of the cooking surface of the cooking member of FIGS. 1-4;

FIG. 6 is a side sectioned view of another embodiment of the surface of the cooking member of FIGS. 1-5;

FIG. 7 is a perspective view of another embodiment of a surface of the cooking member of FIGS. 1-5;

FIG. 8 is a side sectioned view of the surface of the cooking member of FIG. 7;

FIG. 9 is a partially sectioned side view of another embodiment of a popcorn popper of the present invention;

FIG. 10 is a perspective view of the bottom of the popcorn popper of FIG. 9; and

FIG. 11 is a sectioned perspective view of another embodiment of a popcorn popper of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

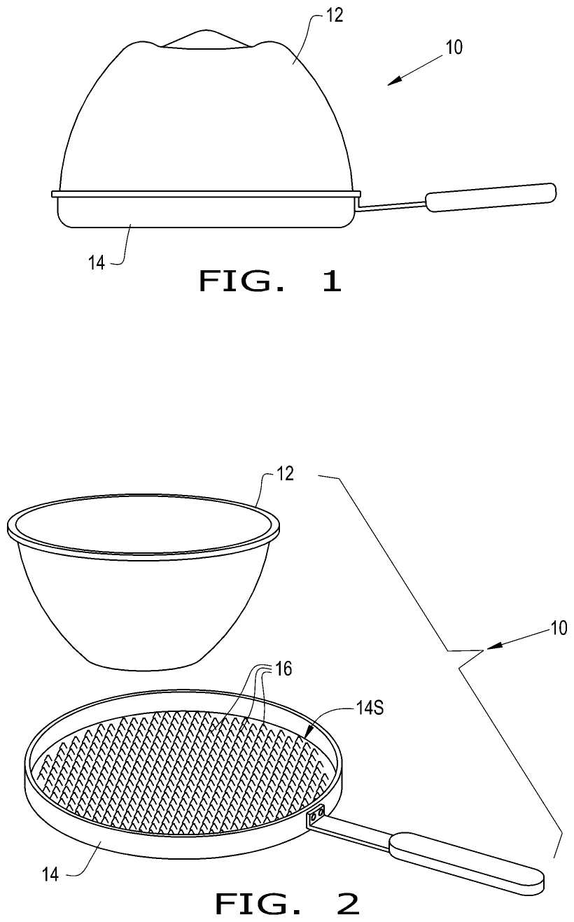

Referring now to the drawings, and more particularly to FIGS. 1-3, there is shown a popcorn popper 10 for popping corn kernels, or other grain kernels, into popcorn. The popcorn popper 10 generally includes a container member or lid 12 and a cooking member 14 with a cooking surface 14S. The popcorn popper 10 may or may not include an integrated heat source, for example an electric heating element.

The container member 12 may cover the cooking member 14 and/or hold the popcorn therein. The container member 12 may be used as a container to hold the popcorn after the popcorn has been cooked by the cooking member 14. The container member 12 may be removably connected to the cooking member 14. For instance, the container member 12 may have a threaded portion or tongue or groove portions which correspondingly engage with a threaded portion or a tongue or groove portion of the cooking member, respectively. The container member 14 may be in the form of a bowl. The container member 14 may comprise any desired size, shape, and material. It should be appreciated that the container member 12 may or may not be included in the popcorn popper 10. In other words, the popcorn popper 10 may simply include the cooking member 14 without a container member.

The cooking member 14 can be in the form of a stove-top pan with a handle. Hence the cooking surface 14S may be in the form of a pan bottom. However, it should be appreciated that the cooking member 14 may include any desired cooking member, such as pot, a tray, or a portion of a popcorn machine. It should also be appreciated that the cooking member 14 may comprise any desired size, shape, and material.

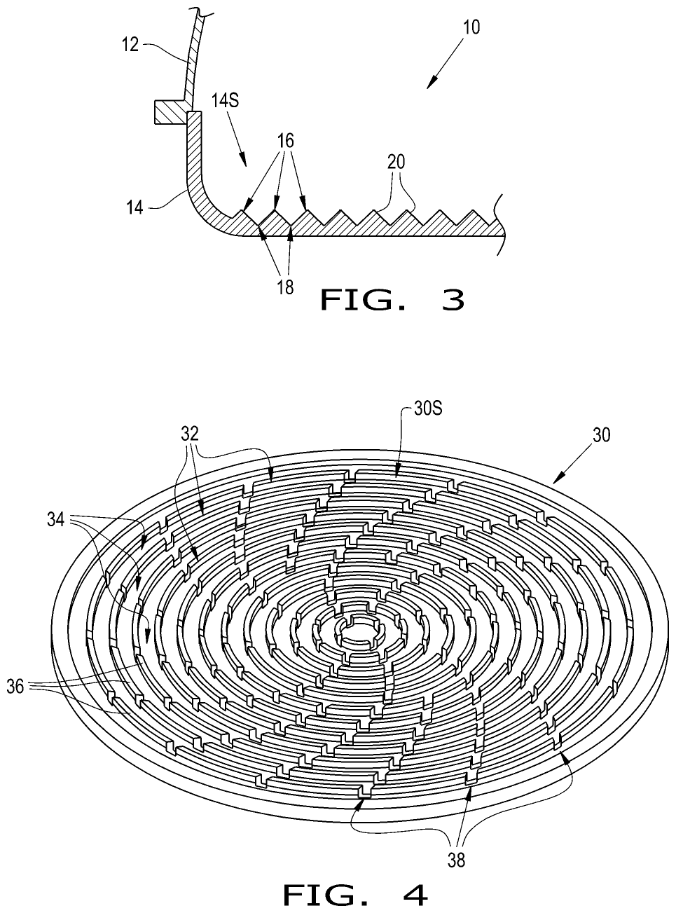

The cooking member 14 has a profiled cooking surface 14S. The cooking surface 14S may comprise multiple protrusions 16 which define grooves 18, i.e., trench-sections in between juxtaposed protrusions 16, and elevated supports 20, i.e., peak-sections of the protrusions 16 (FIG. 3). Upon adding oil to the cooking member 14, the oil will pool in the grooves 18 without reaching up to the elevated supports 20 (FIG. 3). Each protrusion 16 may have angled sides, which create corresponding grooves 18 that are narrower at their bottom and wider at their top. It should be appreciated that the angle of the protrusions 16 may be minimal to allow a greater number of protrusions 16. The protrusions 16 may have any desired size and shape. For instance, the protrusions 16 may have a triangular cross-section (FIG. 3).

Each groove 18 may be larger than the average size of a kernel, allowing oil to flow around the kernel. The oil may at least partially or completely cover the kernel. For example, the oil may reach between ⅓ and ½ of the height of the kernel while the kernel is laying in a given groove 18. The oil may also surround the circumference of the kernel to help transfer heat. Furthermore, each groove 18 may be smaller than the average size of a popped kernel, i.e., a single piece of popcorn, so that the kernel, as it starts to crack, will lift itself up and out of the oil and onto the elevated support(s) 20. In essence, the grooves 18 help to lift the kernels as they crack and expand.

Each elevated support 20, i.e., an upper section of each protrusion 16, may have a starting height which is greater the height of the average sized kernel. Hence, the kernel will rest in the grooves 18, and the popcorn will rest mostly on the elevated supports 20, above and out of the oil. It is noted that the elevated supports 20 may be cooler in relation to the surrounding portions of the cooking member 12 which are closer to the heat source, for example lower sections of the protrusions 16 and/or the bottoms of the grooves 18.

The cooking surface 14S decreases the chance for the popcorn to burn because the cooking surface 14S allows an individual kernel to lift itself up and out of the heated oil, within a given groove 18, after the kernel has popped using only the natural expansion of the kernel as it interacts with the sides of the protrusions 16. It should be appreciated that due to the variances in size of popcorn, some popcorn pieces or portions thereof may nevertheless contact the oil. However, despite such variances in popcorn, the cooking member 14 vastly reduces the oil contact after popping of the kernel has occurred. Thereby, the cooking member 14 may substantially reduce, or even completely eliminate, the need to remove popcorn in order to prevent the popcorn from burning as the remaining kernels continue to cook. Therefore, the cooking member 14 reduces the level of input required by a user in a cost-effective manner.

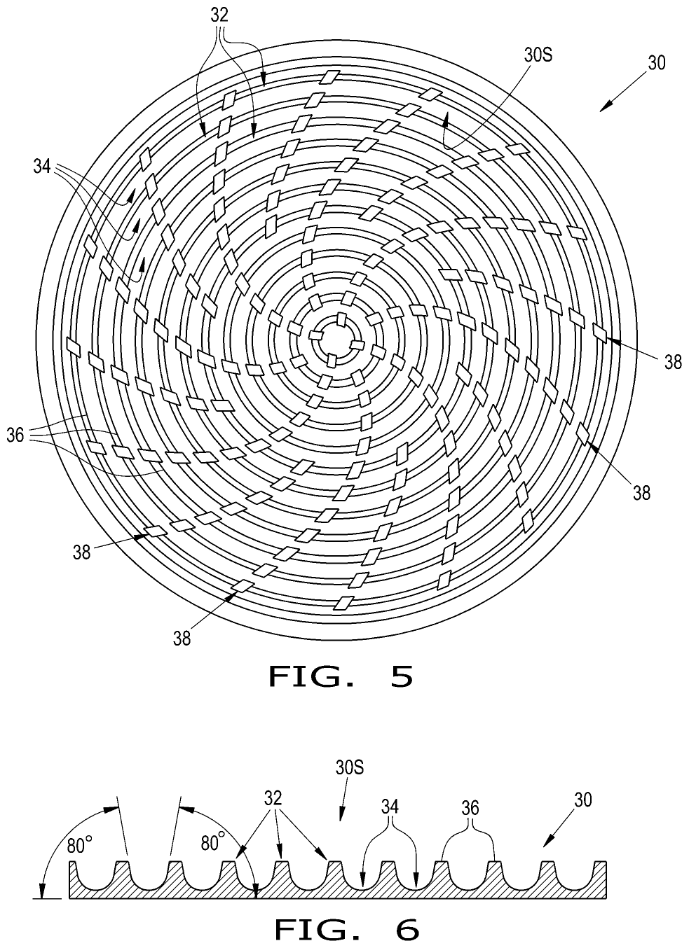

Referring now to FIGS. 4-6, there is shown another embodiment of a cooking member 30 with a ridged cooking surface 30S. The cooking surface 30S may comprise multiple protrusions 32 which define grooves 34 and elevated supports 36. The cooking surface 30S may also include channels 38. It should be appreciated that the cooking member 30 may be substantially similar to the cooking member 14, as described above, except for its cooking surface 30S.

The protrusions 32 may be in the form of multiple concentric ridges 32, which expand outwardly from the center of the cooking member 30. The protrusions 32 may have angled or sloping sides, which correspondingly create grooves 34 that are narrower at their bottom and wider at their top. It should be appreciated that the protrusions 32 may have any desired size and shape. For instance, each protrusion 32 may have curved sides, which define a respective groove 34 in between juxtaposed protrusions 32, and a substantially flat top, which defines a respective elevated support 36 (FIG. 6).

In a similar fashion to the grooves 18 and elevated supports 20 of the cooking member 14, the grooves 34 and elevated supports 36 of the cooking member 30 help to lift the kernels as they pop and subsequently support the popcorn on top of the flat elevated supports 36.

The channels 38 may help to spread the oil through the cooking member 30. The channels 38 may be oriented in a spiral pattern extending outwardly from the center-most protrusion 32. The channels 38 may include multiple, differing sets of channels. For instance, the channels 38 may include a first set of channels that extend from the center-most protrusion to the outer-most protrusion and a second set of channels which extend from a middle protrusion to the outer-most protrusion. The channels 38 may be defined by the resulting gaps in between adjacent protrusions 32. Alternatively, the channels 38 may be machined into the protrusions 32. The channels 38 may comprise any desired size and shape.

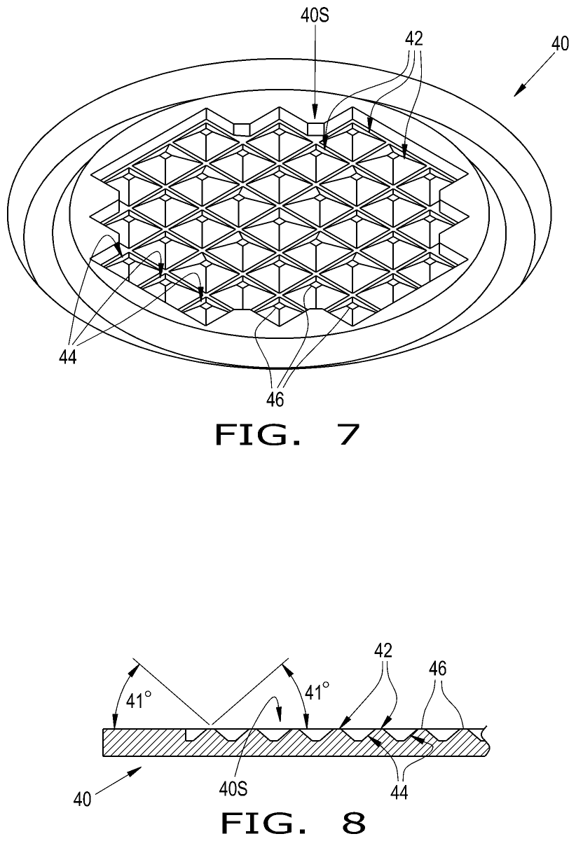

Referring now to FIGS. 7-8 there is shown another embodiment of a cooking member 40 with a cooking surface 40S comprised of multiple protrusions 42 in the form of truncated shapes or frusta. The protrusions 42 may be in the form of pyramidal frustra which collectively define grooves 44 therebetween and flat, elevated supports 46. The protrusions 42 may also be in the form of conical frustra. It should be appreciated that the cooking member 30 may be substantially similar to the cooking members 14, 30 as described above, except for its frusta-type cooking surface 40S.

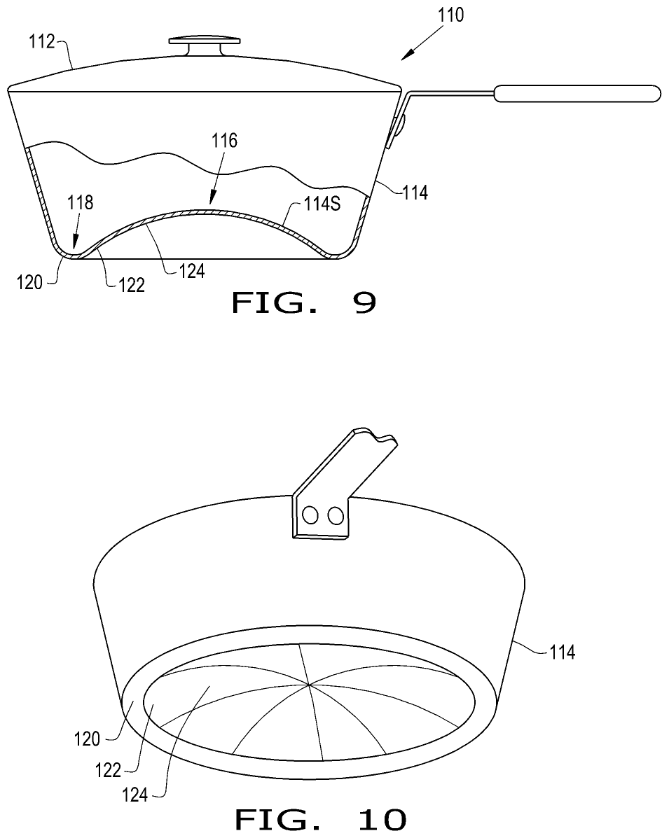

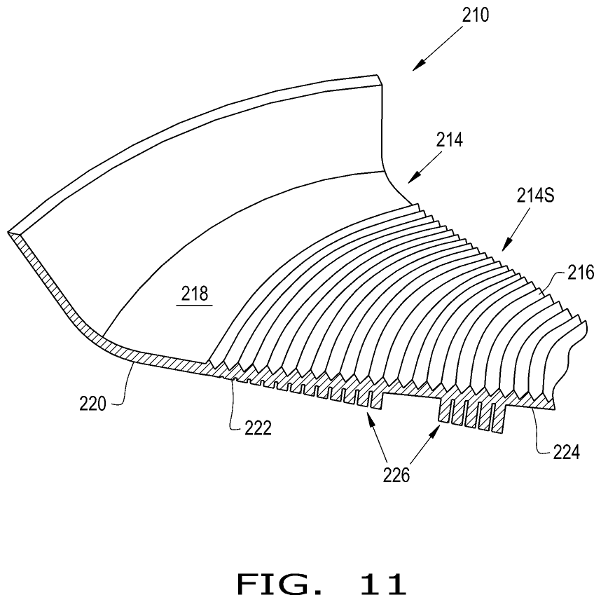

Referring now to FIGS. 9 and 10, there is shown another embodiment of the present invention in the form of a popcorn popper 110 for popping corn kernels, or other grain kernels, into popcorn. The popcorn popper 110 generally includes a lid 112 and a lower cooking member 114 with curved bottom. The popcorn popper 110 may or may not include an integrated heat source, for example an electric heating element.

The cooking member 114 can be in the form of a stove-top pan with a handle. The cooking member 114 has a non-flat bottom. For example, the cooking member 114 may have a curved, rounded, or beveled bottom that extends upwardly into the interior of the cooking member 114. The curved cooking surface 114S of the cooking member 114 defines a heat contact zone 120, a popping zone 122, and a tapered lift zone 124. More particularly, the curved bottom of the cooking member 114 defines an upwardly, i.e., inwardly, extending protrusion 116, also referred to as an elevated support 116 that supports the popped popcorn and a single annular groove 118 spanning the outer perimeter of the bottom of the cooking member 114. The groove 118 receives the oil and holds the popcorn kernels. The cooking member 114 may comprise any desired material, such as metal and/or plastic.

The heat zone has a flat area to contact the stove top. The heat zone may be annular. The popping zone 122, which may closely correspond to the heat zone 120, tapers up into the lift zone 124. The lift zone 124 may define one or more slopes or angles of curvature. For example, the lift zone 124 may gradually taper upwardly and have a single angle of curvature. Alternatively, for example, the lift zone 124 may be tiered.

As the amount of corn and oil are increased or decreased for the portion size, the popping zone can grow up or down the taper taking corn and oil with it. As corn is popped, oil splatters around the bottom of the cooking member 114. Also, along with the splattered oil, popcorn kernels are tossed upwardly. Thereafter, the popcorn kernels roll back down from the lift zone into the popping zone. The lighter and non-round popped popcorn is forced up and away from the popping zone and rests on top of the lift zone.

The cooking member 114 decreases the chance for the popcorn to burn because the curved bottom lifts the popped popcorn away from the heat source. During the cooking process, the popping zone has a greater temperature than the lift zone. Thereby, the remaining popcorn kernels may continue cooking in the groove 118, at a higher temperature, as the popped popcorn rests on top of the lift zone, at a lower temperature.

Referring now to FIG. 11 there is shown yet another embodiment of the present invention in the form of a popcorn popper 210 for popping corn kernels, or other grain kernels, into popcorn. The illustration in FIG. 11, is a sectioned view, with popper 210 having at least some of the features of previous embodiments, even though not shown. Popcorn popper 210 generally includes a lid, not shown, and a lower cooking member 214 with an angled bottom. The popcorn popper 210 may or may not include an integrated heat source, for example an electric heating element.

The cooking member 214 can be in the form of a stove-top pan with a handle. The cooking member 214 has a non-flat bottom. For example, the cooking member 214 may have a curved, rounded, or beveled cooking surface 214S that extends upwardly into the interior of the cooking member 214. The bottom of the cooking member 214 defines a heat contact zone 220, a popping zone 222, and a lift zone 224. Further, cooking member 214 also includes downwardly extending protrusions 226 that can be spaced apart and have gaps, which vary the heat conduction up to the interior bottom surface. More particularly, the cooking surface of the cooking member 214 includes a single annular groove 218 spanning the outer perimeter of the bottom of the cooking member 214. The groove 218 receives the oil and holds the popcorn kernels.

The heat zone 220 has a flat area to contact the stove top. The heat zone may be annular. The popping zone 222, which may closely correspond to the heat zone 220, tapers up into the lift zone 224. The lift zone 224, which may also be considered an elevated support 224, may define one or more slopes or angles of curvature. For example, the lift zone 224 may gradually taper upwardly and have a single angle of curvature. Alternatively, for example, the lift zone 224 may be tiered.

As can be seen in several of the figures most of the elevated supports 16, 20, 36 have corresponding ones of grooves 18, 34 along at least two sides of the elevated supports. Cooking member 14 has a bottom on a side opposite the cooking surface 14S that is flat.

In some embodiments of the present invention cooking member 114 has a bottom on a side opposite the cooking surface 114S that is concave.

Elevated supports 16, 36 may be formed in substantially concentric rings on the cooking surface 14S, 214S. The concentric rings may have gaps or channels 38 therein allowing oil on the cooking surface to flow between the elevated supports 16, 36.

In some embodiments of the present invention the cooking surface 114S, 214S can be elevated toward a middle of the cooking member. The groove 118, 218 is concentric to the middle of the cooking surface, with the groove 118, 218 being between the elevated support 116, 216 and the perimeter of the cooking surface 114S, 214S.

The elevated supports 216 ascend along the cooking surface 214S from the groove 218 to the middle of the cooking surface 214S. In the present invention the elevated supports 16, 32, 42, 216 are generally or substantially similar in shape within each embodiment.

Downwardly extending protrusions 226 conduct heat to the cooking surface 214S with the heat conduction of the protrusions 226 to the cooking surface 214S varying based on a distance from the groove 218. The protrusions 226 are arranged so that less heat is conducted to the middle of the cooking surface and more heat is conducted to the groove 218. Protrusions 226 have gaps therein denoting an area where less heat will be conducted. It is also contemplated that protrusions 226 may be internal to cooking member 214 with a further member covering the bottom side of protrusions 226.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A popcorn popper, comprising:
a cooking member having a cooking surface with at least one elevated support and at least one groove, the at least one elevated support providing for a downward flow of oil toward the at least one groove and an upward support of popped grain thereon.

2. The popcorn popper of claim 1, wherein the at least one elevated support is a plurality of elevated supports.

3. The popcorn popper of claim 2, wherein the elevated supports are substantially similar in shape.

4. The popcorn popper of claim 3, wherein the at least one groove is a plurality of grooves with most of the elevated supports having corresponding ones of the grooves along at least two sides of the elevated supports.

5. The popcorn popper of claim 4, wherein the cooking member has a bottom on a side opposite the cooking surface that is flat.

6. The popcorn popper of claim 4, wherein the cooking member has a bottom on a side opposite the cooking surface that is concave.

7. The popcorn popper of claim 4, wherein the elevated supports have a triangular cross-section.

8. The popcorn popper of claim 4, wherein the elevated supports have truncated, frusta or pyramidal frustra shapes.

9. The popcorn popper of claim 4, wherein the elevated supports are formed in substantially concentric rings on the cooking surface.

10. The popcorn popper of claim 9, wherein the concentric rings have gaps or channels therein allowing oil on the cooking surface to flow between the elevated supports.

11. A popcorn popper, comprising:
a cooking member having a cooking surface with at least one elevated support and at least one groove, the at least one elevated support providing for a downward flow of oil toward the at least one groove and an upward support of popped grain thereon; and
a lid removably placed on the cooking member.

12. The popcorn popper of claim 11, wherein the cooking surface is elevated toward a middle of the cooking surface.

13. The popcorn popper of claim 12, wherein the groove is concentric to the middle of the cooking surface, the groove being between the elevated support and the perimeter of the cooking surface.

14. The popcorn popper of claim 13, wherein the at least one elevated support is a plurality of elevated supports that ascend along the cooking surface from the groove to the middle of the cooking surface.

15. The popcorn popper of claim 14, wherein the elevated supports are substantially similar in shape.

16. The popcorn popper of claim 14, wherein the elevated supports are arranged in a concentric manner on the cooking surface.

17. The popcorn popper of claim 14, wherein the elevated supports have a triangular cross-section.

18. The popcorn popper of claim 14, further comprising downwardly extending protrusions that conduct heat to the cooking surface the heat conduction of the protrusions to the cooking surface varying based on a distance from the groove.

19. The popcorn popper of claim 18, wherein the protrusions are arranged so that less heat is conducted to the middle of the cooking surface and more heat is conducted to the groove.

20. The popcorn popper of claim 18, wherein the protrusions have gaps therein.
